(19) United States
(12) Patent Application Publication
(10) Pub. No.: US 2008/0267120 A1
(43) Pub. Date: Oct. 30, 2008

(54) Location Services for Unlicensed Mobile Access

(76) Inventors: Jarko Niemenmaa, Espoo (FI); Sabastian Kraufvelin, Tenhola (FI); Ville Ruutu, Espoo (FI)

Correspondence Address: HAYNES AND BOONE, LLP, 901 Main Street, Suite 3100, Dallas, TX, 75202, US

(21) Appl. No.: 11/908,261

(22) PCT Filed: Mar. 7, 2006
(86) PCT No.: PCT/IB06/00540

§ 371 Date: Jul. 10, 2008

(51) Int. Cl. H04Q 7/00

(52) U.S. Cl. 370/329

(57) ABSTRACT

There- is disclosed an unlicensed mobile access network (122) comprising an unlicensed mobile access network controller (126) or a generic access network comprising a generic access network controller and a serving mobile location centre (150), each being adapted to communicate with each other via an Internet protocol based communication link.

### BACKGROUND TO THE INVENTION

1. Field of the Invention

The present invention relates to unlicensed mobile access or similar networks such as 3GPP “Generic Access to A/Gb Interface” solution, and more particularly to the support of location services in such networks.

2. Description of the Related Art

“Unlicensed Mobile Access” (UMA) is a proposal to create a BSS (base station sub-system) look-alike access system architecture for “tunneled GSM” over two existing unlicensed-band radio interfaces: Bluetooth and WiFi (802.11). It is proposed that UMA may be used, for example, for coverage extensions in indoor applications (such as home or office applications) to capture otherwise fixed line traffic for cellular operators. In the US, UMA is perceived as a cheaper way to provide missing coverage to domestic users at home than via a macro network (e.g. GSM and UMTS).

There is a current European proposal to use UMA architectures in combination with a GSM (global system for mobile communication) RAN (radio access network), known as a GERAN. The unlicensed mobile access network (UMAN) is proposed to consist of UMA network controllers (UNCs), and access points (APs), which APs conform to a BlueTooth or WiFi standard as appropriate.

The UMA signaling protocol architecture for circuit switched domain (between a mobile station, an access point, and an UNC) is shown in FIG. 1.

A consortium of companies (reference can be made to http://www.umatechnology.org/) have drafted specifications for UMANs.

At least some of these UMAN specifications include some discussion of location services (LCS).

The published document “UMA Architecture (Stage 2) R1.0.2” discusses LCS support. Specifically discussed is emergency service support for United States Federal Communications Code (FCC) E911 Phase 2 requirements. A number of ways in which the location of a terminal performing an emergency call may be obtained are discussed (in chapter 9.17.2.1). In one way the UNC may maintain a database of AP locations. The AP location is provided from a terminal via a known URR REGISTER REQUEST/URR REGISTER UPDATE message or via some management interface. In another way the terminal may provide its current location (e.g. obtained via A-GPS) in a URR REGISTER/UPDATE message. In another way the UNC can look up a location database based on a public IP address and/or MAC address of a terminal.

Location services are discussed in chapter 9.18 of the published document “UMA Architecture (Stage 2) R1.0.2”. Cell information (of possibly available GSM coverage) may be used by the UNC to determine the location of a terminal. As another possibility, the AP identity is mentioned. Cell and AP information can be provided from the terminal to the UNC using URR-REGISTER and URR-REGISTER UPDATE messages.

Likewise, the document “UMA Protocols (Stage 3) R1.0.2” discusses LCS support. URR REGISTER REQUEST and URR REGISTER UPDATE UPLINK messages are identified as including the following information elements (IE) useful for location purposes: AP radio identity; cell identity; Geographic Location; and AP location. AP radio identity IE is used for transmission of Bluetooth Device address (BD_ADDR) or WLAN MAC Address of AP. There is a field called “Type of Identity” which contains only a value “IEEE MAC-address format”. Other values are for future use. A cell identity IE identifies the cellular cell. A geographic location IE can be used to deliver, for example, an A-GPS location estimate from the terminal. An AP location IE is for indicating the location of a terminal or an AP to the network.

It has been proposed in the UMA Forum that the Lb interface should be used between a UMA network controller (UNC) and a serving mobile location centre (SMLC). The Lb interface is the 3GPP GERAN standardized interface between a base station controller (BSC) and the SMLC. The Lb interface and the protocol stack between a SMLC, BSC, and Mobile Station (MS) (as described in 3GPP TS 43.059 v6.4.0) is shown in FIG. 2.

The RRLP (Radio Resource LCS Protocol) is a protocol that defines the location related information exchanged directly between a MS and the SMLC. Currently the RRLP supports Enhanced Observed Time Difference (E-OTD), Global Positioning System (GPS), and Assisted GPS (A-GPS) location methods.

In 3GPP standardization organization there is a Release 6 work item called “Generic Access to A/Gb Interface”. This is in practice the UMA solution for 3GPP standards. For example the 3GPP technical specification 43.318 is the Stage 2 document for Generic Access to A/Gb Interface. In 3GPP terminology the UNC is called Generic Access Network Controller (GANC). The Lb interface has been defined between the GANC and the SMLC.

The TS 43.318 defines similar LCS support as UMA. Emergency call location is discussed. Access point ID to location mapping is mentioned. It is also possible that the terminal can provide its location (e.g. via AGPS). Terminal (public) IP address to location mapping is mentioned.

The proposal to use the 3GPP standardised Lb interface between the UNC or GANC and the SMLC has merits, such as the possibility to reuse existing GERAN SMLCs. However, the 3GPP Lb also has various drawbacks.

The Lb interface was originally planned for circuit-switched use, based on SS7. It is thus not optimized for a modern packet-based data transfer environment (UMA has adopted IP as its main transport means). For example, on the Lb interface, a transaction is identified based on an under-laying SCCP connection, which is an unnecessary complication in an IP based environment.

The UMA or generic access points are typically standard WLAN or Bluetooth access points (APs). Thus an UMA or generic access operator cannot control their exact geographical locations in the same way as, for example, the operators of cellular base stations. An UNC/GANC is the network element that is likeliest to have the best information about AP locations (which is important data for UMA location services). However the Lb interface does not support delivery of such operations and maintenance (O&M) type information.

The Lb interface has been planned for use between a BSC and a SMLC. There are various GERAN specific features that are not applicable with UMAN or generic access network. For example, BSSLAP protocol includes messages to request and deliver GSM Timing Advance (TA) information from the BSC to the SMLC. Such TA information is not available in UMAN or generic access network. Such discrepancies may lead to problematic situations (e.g. a GERAN SMLC is reused for a UMAN location, and it assumes that it is dealing with a GERAN, and that it gets valid TA values etc.).

The Lb interface does not necessarily support all relevant information from UMAN or generic access network location point of view. For example, details of UMA radio access can be useful for location determination (access type, signal strengths etc.), but the Lb interface does not support delivery of such information.

It is an aim of the invention to address one or more of the above-stated problems.

### SUMMARY OF THE INVENTION

According to the invention there is provided an Internet protocol based communication link for providing a connection between an unlicensed mobile access network controller or generic access network controller and a serving mobile location centre.

The communication link may be adapted to support unlicensed mobile access or generic access location services functionality.

The communication link may be adapted to support the transmission of access point characteristics or signal strength measurements to support location services.

The communication link may be adapted to support the transmission of access point locations from the unlicensed mobile access network controller or generic access network controller to the serving mobile location centre.

The invention also provides an unlicensed mobile access network controller or generic access network controller comprising an interface for connection to an Internet protocol based communication link for providing a connection to a serving mobile location centre.

The unlicensed mobile access network controller or generic access network controller may be further adapted to transmit location services information on said communication link.

Said location services information may include access point location information.

The unlicensed mobile access network controller or generic access network controller may further comprise a database for storing access point location information.

The access point location information may be received from a mobile station connected to the controller via an access point.

The invention still further provides a serving mobile location centre comprising an interface for connection to an Internet protocol based communication link for providing a connection to an unlicensed mobile access network controller or generic access network controller.

The serving mobile location centre according to may further be adapted to receive location services information on said communication link.

Said location services information may include access point location information.

Said location services information may include an identification of the transmission range of an access point.

Said location services information may include location coordinates.

The invention yet further provides an unlicensed mobile access network comprising an unlicensed mobile access network controller or a generic access network comprising a generic access network controller and a serving mobile location centre, each being adapted to communicate with each other via an Internet protocol based communication link.

Said communication link may be adapted to support unlicensed mobile access or generic access location services functionality, respectively.

In a further aspect the invention provides a method of communicating between an unlicensed mobile access network controller or generic access network controller and a serving mobile location centre comprising transmitting on an Internet protocol based communication link.

The step of communicating may comprise transmitting location services information from the unlicensed mobile access network controller or generic access network controller and a serving mobile location centre.

The step of transmitting location services information may comprise transmitting access point location information, or geographical coordinates, or the transmission range of an access point.

The invention also provides an Internet protocol based communication link for providing a connection between a generic access network controller and a location services entity. The location services entity may be an SMLC in certain embodiments, or any other suitable location services entity, such as a position determination entity in other embodiments, but generally any entity which provides location services support.

The communication link is thus adapted to support location services functionality.

The invention also provides a generic access network controller comprising an interface for connection to an Internet protocol based communication link for providing a connection to a location services entity.

The invention provides a location services entity comprising an interface for connection to an Internet protocol based communication link for providing a connection to a generic access network controller.

The invention provides an unlicensed mobile access network comprising a generic access network comprising a generic access network controller and a location services entity, each being adapted to communicate with each other via an Internet protocol based communication link.

The invention provides a method of communicating between a generic access network controller and a location services entity comprising transmitting on an Internet protocol based communication link.

The step of communicating preferably comprises transmitting location services information from the generic access network controller to the location services entity.

### BRIEF DESCRIPTION OF THE FIGURES

The invention is described by way of example with reference to the accompanying figure in which:

FIG. 1 illustrates a UMA signaling protocol architecture for circuit switched domain;

FIG. 2 illustrates signaling between a serving mobile location centre and a target mobile station in the circuit switched domain in a GERAN;

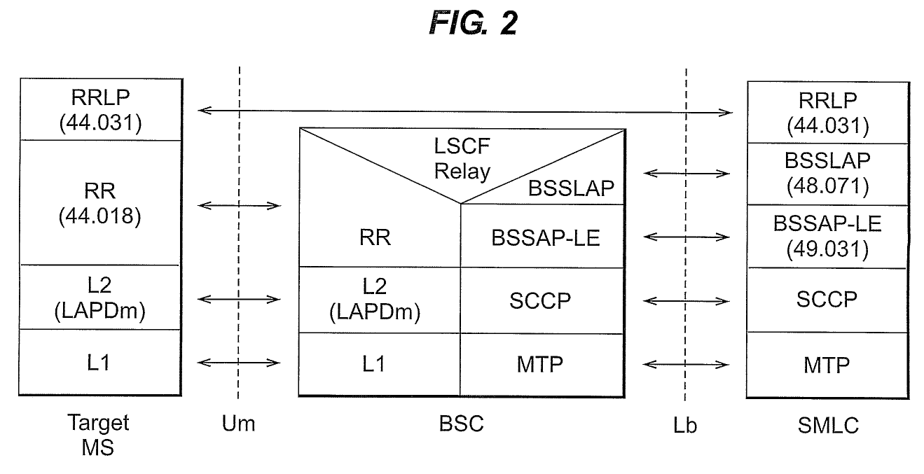

FIG. 3 illustrates a proposed unlicensed mobile access architecture in which the invention and embodiments thereof may be implemented;

FIG. 4 illustrates RRLP over UMA-RR signaling protocol architecture for a circuit switched domain in an embodiment;

FIG. 5 illustrates RRLP measure position procedure with new RRLP carrying URR message in an embodiment; and

FIG. 6 illustrates RRLP assistance data procedure with new RRLP carrying URR message in an embodiment.

### DESCRIPTION OF THE PREFERRED EMBODIMENTS

The invention is described herein by way of example with reference to a number of embodiments. The invention is described in the context of an unlicensed mobile access system operating in conjunction with a licensed mobile access system, and specifically, in exemplary embodiments, a GERAN system.

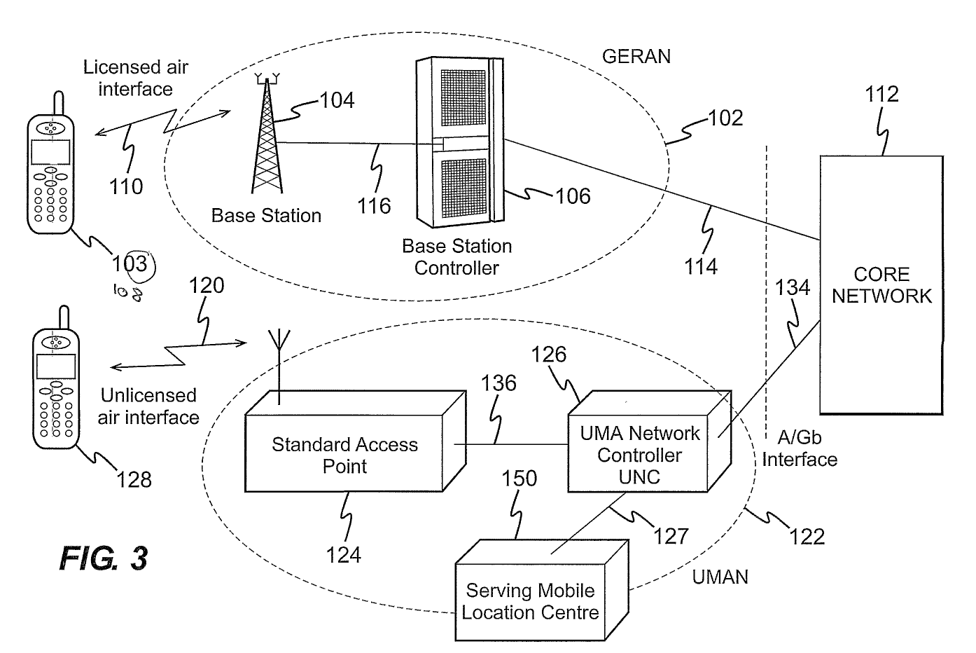

With reference to FIG. 3, there is shown a GERAN 102 including at least one base station 104 and at least one base station controller 106. A mobile station 108 is connected, via a licensed air interface 110, to the base station 104 of the GERAN 102. The base station 104 is connected to the base station controller 106 via a communication link 116. The base station controller 106 is connected to a core network 112 via an A/Gb interface connection 114.

With further reference to FIG. 3, there is shown a UMA network 122 including at least one standard access point 124, or network access point, and at least one UMA network controller (UNC) 126, or network control element. A mobile station 128, being a UMA terminal, is connected, via an unlicensed air interface 120, to the standard access point 124 of the UMAN 122. The standard access point 124 is connected to the UNC 126 via a communication link 136. The UNC 126 is connected to the core network 112 via an A/Gb interface connection 134.

The architecture of network arrangements as so far described with reference to FIG. 3 is known to those skilled in the art. It should be noted that the mobile stations 108 and 128 are preferably configured to connect in either a GERAN or a UMAN, in accordance with available network coverage and implementation requirements.

A SMLC 150 is provided as part of the UMAN 122. In accordance with aspects of the present invention, a connection between the SMLC 150 and the UNC 126 is provided by a specific Internet Protocol based interface 127 for communication between the UNC and the SMLC.

The preferable characteristics of the interface 127 are discussed below.

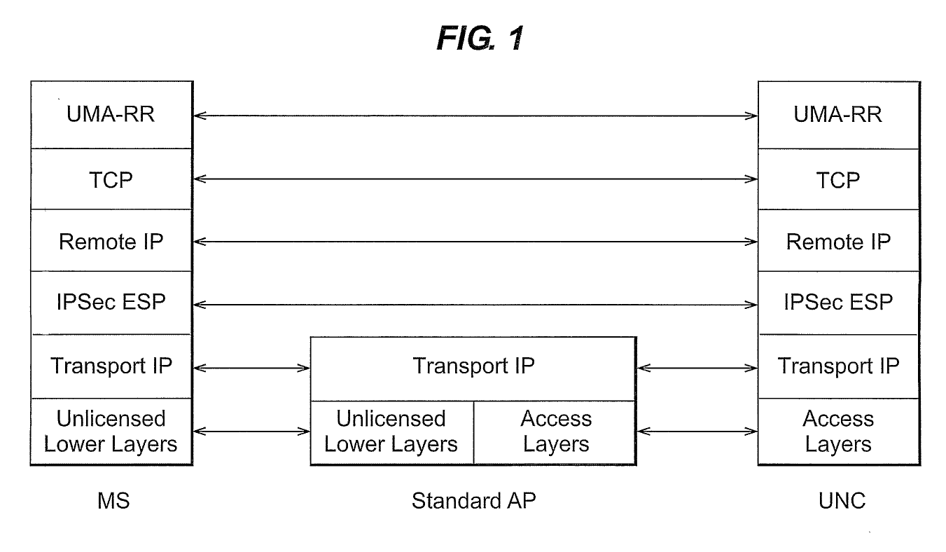

The interface is based on the Internet protocol (IP) which protocol has already adopted to a large extent in UMA (as can be seen from FIG. 1). The use of such a protocol also has the benefit of avoiding SS7.

The interface 127 does not contain or support features which are irrelevant from a UMA location point of view, and therefore only useful traffic is transported on the interface.

The interface 127 is preferably adapted to support relevant features from a UMA location point of view, such as access point characteristics, signal strengths etc. This is discussed in further detail hereinbelow by way of exemplary embodiments.

The interface 127 is preferably adapted to support delivery of operation and maintenance type information.

In particular the interface 127 preferably supports delivery of access point locations from the UNC 126 to the SMLC 150. This is useful as an UNC is likely to have the latest information related to access points under its control. For example, the AP locations may be available for UNC due to an UNC having AP locations configured in a database thereof; or due to an “AP Location IE” (access point location information element) in URR messages (such as URR REGISTER REQUEST/URR REGISTER UPDATE messages) delivering AP locations to the UNC 126.

When an UNC is relatively sure that an AP is near to a mobile station (MS), and the MS is capable of indicating its location (e.g. by way of a GPS location estimate), the UNC 126 can deduce the AP location as well. The UNC may also collect such MS location information, and then statistically estimate the AP location based on individual MS location estimates.

Embodiments of location services techniques enhanced by the use of the IP interface between the UNC 126 and the SMLC 150 are described further hereinbelow. In general, the interface provides a communication link between the UNC and the SMLC, and each of the UNC and the SMLC is provided with an interface for connecting to such link, such that they may receive and transmit on such link.

Embodiments of the invention provide for an enhancement to an unlicensed mobile access so that it is possible to transfer E-OTD, GPS, and A-GPS related information between mobile stations and UNCs.

In embodiments this is preferably done either by: including in UMA messages specific information elements; or by allowing RRLP messages to be transported in UMA signaling, i.e providing containers for RRLP messages.

Referring to the FIG. 1, the preferred layer for this is the UMA-RR layer. There are two alternatives for this. In a first possibility a new Unlicensed Radio Resources (URR) message is created that contains A-GPS and other information. In a second possibility some existing URR messages are enhanced to contain new information elements.

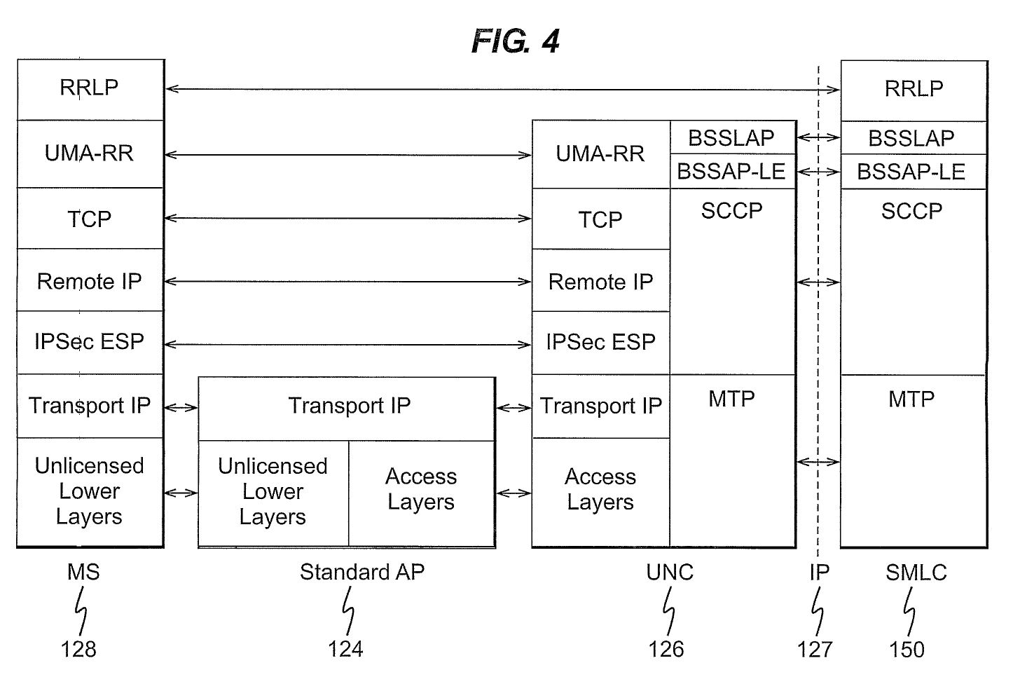

By way of an implementation example, a case may be considered with new URR messages that contain RRLP messages. The protocol stack would then be as shown in FIG. 4. Note the use of the IP interface 127 between the UNC 126 and the SMLC 150 in accordance with the invention.

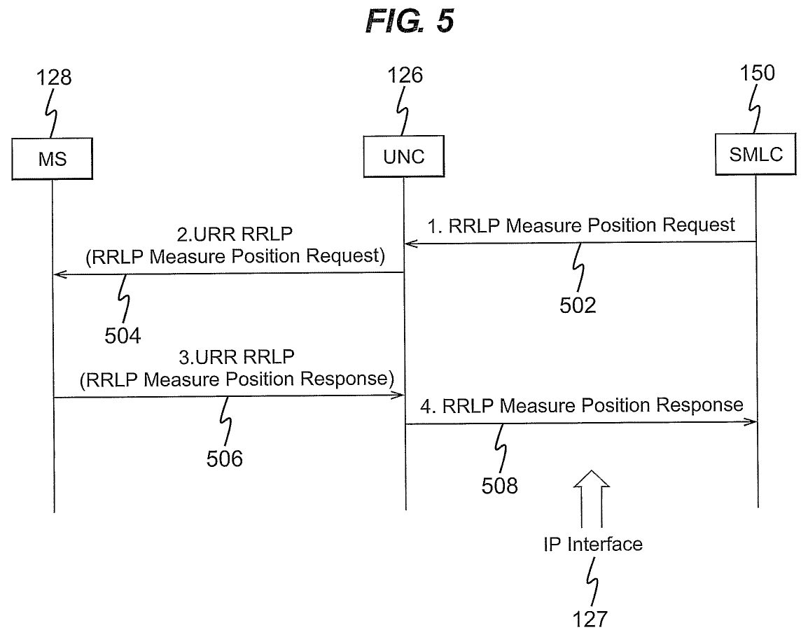

One possible signaling scenario is as shown in FIG. 5, for an RRLP measure position procedure.

As represented by message 502, the SMLC 150 sends a RRLP Measure Position Request to the UNC 126 over the IP interface 127. This RRLP message may, for example, carry a request for location information, and it may also contain GPS assistance data.

The UNC 126 packs the RRLP Measure Position Request into a new “URR RRLP” message 504 that it sends to the MS 128. URR RRLP is a specific URR message intended to carry RRLP messages between the UNC and MSs.

The MS 128 responds with a RRLP Measure Position Response message, that may contain for example an A-GPS location estimate, embedded in a URR RRLP message 506.

The UNC 126 forwards the RRLP Measure Position Response 508 to the SMLC 150 over the IP interface 127.

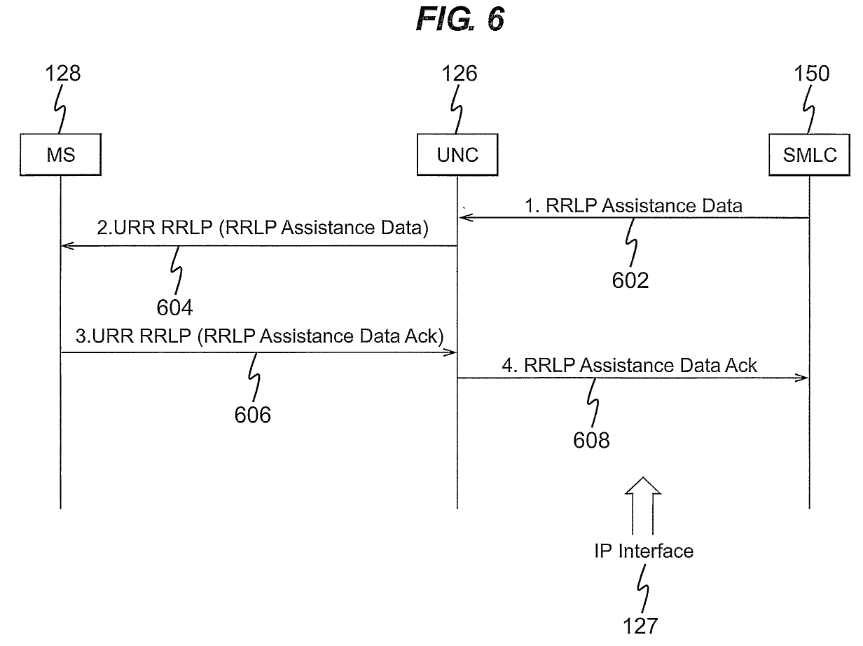

In a similar fashion, the RRLP Assistance data procedure according to an embodiment of the invention is described with reference to FIG. 6.

The SMLC 150 sends a RRLP Assistance Data message 602 to the UNC 126 over the IP interface 127. This RRLP message may for example carry GPS assistance data.

The UNC 126 packs the RRLP Assistance Data into a URR RRLP message 604 that it sends to the MS 128.

The MS 128 responds with a RRLP Assistance Data Ack. message embedded in a URR RRLP message 606.

The UNC 126 forwards the RRLP Assistance Data Ack. Message 608 to the SMLC 150 over the IP interface 127.

Embodiments of the invention advantageously provide an A-GPS and E-OTD location method which can be used with UMA, without needing new hardware.

As A-GPS is the main location method in 3G and 2G mobile communication standards, a mechanism to carry A-GPS assistance data from the UNC to the mobile is advantageous.

The invention as described herein provides several advantages. There is provided an optimised interface between an UNC and a SMLC. “GERAN legacy” features and problems are avoided. New features relevant for UMA location can be supported. There is a better fit with the overall IP approach of UMA. A solution is provided for potentially troublesome O&M handling, especially as it relates to access point coordinates. No new hardware is needed

Embodiments of the invention also provide for various advantages and improvements to the art. These advantages include improved location information. The uncertainty of location information can be estimated. Easy implementation is allowed for. No new hardware is needed.

The above description of the preferred embodiments has been given using an UMA network as an example, but it will be understood by one skilled in the art that they likewise apply to Generic Access to A/Gb Interface networks. An UMA network may be considered an example of a Generic Access to A/Gb Interface network.

The principles of the invention also extend to solutions where a UMA or more generally a generic access network is supported, for example, in CDMA/CDMA2000 networks. In such networks a position determination entity is provided in place of the SMLC. IS-801 corresponds to the RRLP.

Various modifications to the described embodiments will be understood by one skilled in the art. The scope of protection afforded by the invention is defined by the appended claims.

1. An Internet protocol based communication link for providing a connection between an unlicensed mobile access network controller or generic access network controller and a serving mobile location centre.

2. A communication link according to claim 1 being adapted to support unlicensed mobile access or generic access location services functionality.

3. A communication link according to claim 2 being adapted to support the transmission of access point characteristics or signal strength measurements to support location services.

4. A communication link according to claim 2 or claim 3 being adapted to support the transmission of access point locations from the unlicensed mobile access network controller or generic access network controller to the serving mobile location centre.

5. An unlicensed mobile access network controller or generic access network controller comprising an interface for connection to an Internet protocol based communication link for providing a connection to a serving mobile location centre.

6. An unlicensed mobile access network controller or generic access network controller according to claim 5 further adapted to transmit location services information on said communication link.

7. An unlicensed mobile access network or generic access network according to claim 6 wherein said location services information includes access point location information.

8. An unlicensed mobile access network controller or generic access network controller according to claim 7 further comprising a database for storing access point location information.

9. An unlicensed mobile access network controller or generic access network controller according to claim 7 wherein the access point location information is received from a mobile station connected to the controller via an access point.

10. A serving mobile location centre comprising an interface for connection to an Internet protocol based communication link for providing a connection to an unlicensed mobile access network controller or generic access network controller.

11. A serving mobile location centre according to claim 10 further adapted to receive location services information on said communication link.

12. A serving mobile location centre according to claim 11 wherein said location services information includes access point location information.

13. A serving mobile location centre according to claim 11 or claims 12 wherein said location services information include an identification of the transmission range of an access point.

14. A serving mobile location centre according to any one of claims 11 to 13 wherein said location services information includes location coordinates.

15. An unlicensed mobile access network comprising an unlicensed mobile access network controller or a generic access network comprising a generic access network controller and a serving mobile location centre, each being adapted to communicate with each other via an Internet protocol based communication link.

16. An unlicensed mobile access network or a generic access network according to claim 15 wherein said communication link is adapted to support unlicensed mobile access or generic access location services functionality, respectively.

17. A method of communicating between an unlicensed mobile access network controller or generic access network controller and a serving mobile location centre comprising transmitting on an Internet protocol based communication link.

18. A method according to claim 17 wherein the step of communicating comprises transmitting location services information from the unlicensed mobile access network controller or generic access network controller and a serving mobile location centre.

19. A method according to claim 18 wherein the step of transmitting location services information comprises transmitting access point location information, or geographical coordinates, or the transmission range of an access point.

20. An Internet protocol based communication link for providing a connection between a generic access network controller and a location services entity.

21. A communication link according to claim 20 being adapted to support location services functionality.

22. A generic access network controller comprising an interface for connection to an Internet protocol based communication link for providing a connection to a location services entity.

23. A location services entity comprising an interface for connection to an Internet protocol based communication link for providing a connection to a generic access network controller.

24. An unlicensed mobile access network comprising a generic access network comprising a generic access network controller and a location services entity, each being adapted to communicate with each other via an Internet protocol based communication link.

25. A method of communicating between a generic access network controller and a location services entity comprising transmitting on an Internet protocol based communication link.

26. A method according to claim 25 wherein the step of communicating comprises transmitting location services information from the generic access network controller to the location services entity.
